(19) United States
(12) Patent Application Publication
(10) Pub. No.: US 2008/0036707 A1
(43) Pub. Date: Feb. 14, 2008

(54) ORGANIC LIGHT-EMITTING DISPLAY APPARATUS, AND METHODS FOR MANUFACTURING AND DRIVING THE SAME

(76) Inventors: Si-Duk SUNG, Seoul (KR); Byung-Sik Koh, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/835,961

(22) Filed: Aug. 8, 2007

(30) Foreign Application Priority Data
Aug. 10, 2006 (KR) 2006-75716

(51) Int. Cl. G09G 3/30

(52) U.S. Cl. 345/76

(57) ABSTRACT

A more simplified organic light-emitting display (OLED) apparatus includes a display panel, gate and data driving circuit parts. The display panel includes an organic light-emitting element having an organic light-emitting layer disposed between first and second electrodes, to emit light. Driving and common voltages are respectively applied to the first and second electrodes. A gate driving circuit part is connected to a first side of the display panel to apply a gate signal, and the gate circuit driving part also applies the common voltage to a first common electrode formed at the first side and is electrically connected to the second electrode. A data driving circuit part is connected to a second side of the display panel to apply a data signal, and the data driving part also applies the common voltage to a second common electrode formed at a third side and electrically connected to the second electrode.

### CROSS-REFERENCE TO RELATED APPLICATIONS

This application claims priority under 35 U.S.C. § 119 to Korean Patent Application No. 2006-75716, filed on Aug. 10, 2006 in the Korean Intellectual Property Office (KIPO), the contents of which are herein incorporated by reference in their entirety.

### BACKGROUND OF THE INVENTION

1. Field of the Invention

The present invention relates to an organic light-emitting display (OLED) apparatus and, more particularly, to an OLED having a simplified structure and methods for manufacturing and driving the OLED display apparatus.

2. Description of the Related Art

Organic light-emitting display (OLED) apparatus that requires lower driving voltages and has lower power consumption has recently seen wider application. In the OLED apparatus, first and second electrodes are formed on an insulating substrate having a thin-film transistor (TFT). The organic light-emitting layer is formed between the first and second electrodes to display an image. Driving and common voltages are respectively applied to the first and second electrodes through data and gate driving circuit parts formed at first and second sides of an insulating substrate.

As the OLED apparatus becomes larger, the increased driving and common voltages are required necessitating the use of additional printed circuit boards (PCBs) disposed at third and fourth side surfaces of the insulating substrate. However, the PCB disposed at all sides of the insulating substrate makes a structure of the OLED apparatus complex.

### SUMMARY OF THE INVENTION

The present invention provides an organic light-emitting display (OLED) apparatus for eliminating additional printed circuit boards (PCBs) and applying driving and common voltages from all sides of the insulating substrate together with a method for manufacturing the OLED apparatus.

The present invention also provides a method for driving the OLED apparatus.

In an exemplary display apparatus according to the present invention, the OLED apparatus includes a display panel, a gate driving circuit part and a data driving circuit part. The display panel includes an organic light-emitting element having an organic light-emitting layer disposed between first and second electrodes on a substrate. A driving voltage is applied to the first electrode, and a common voltage is applied to the second electrode. A gate driving circuit part is connected to a first side of the display panel to apply a gate signal The gate driving circuit part also applies a common voltage to a first common electrode that is formed at the first side and which is electrically connected to the second electrode. A data driving circuit part is connected to a second side of the display panel substantially perpendicular to the first side to apply a data signal, and applies the common voltage to a second common electrode that is formed at a third side facing the first side and is electrically connected to the second electrode.

The display panel may further include a first driving electrode that is formed at the second side and is electrically connected to the first electrode and the data driving circuit part.

The data driving circuit part may include a plurality of data films connected to the second side and having a power applying line part formed on the data films. A data driving chip is disposed on each data film, and a data PCB is electrically connected to the data films. The power applying line part is formed at both sides substantially parallel with the second side and applying one of the driving and common voltages. The second common electrode is electrically connected to the power applying line part of the data film corresponding to the third side.

The data film may further include a gate signal applying line part that is formed inside of the power applying line part to apply the gate signal to the gate driving circuit part. The gate signal applying line part corresponding to the third side of the display panel is electrically connected to the second common electrode to apply the common voltage. The width of the power applying line part electrically connected to the second common electrode and that of the gate signal applying line part are between about 4 mm and about 6 mm.

The display panel may further include a second driving electrode formed at a fourth side corresponding to the second side, and a power supply part disposed at an edge at which the third and fourth sides face each other, to apply the driving voltage to the second driving electrode and to apply the common voltage to the second common electrode.

The gate driving circuit part may include a plurality of substantially parallel gate films connected with the first side, a gate driving chip disposed on each gate film, common voltage films disposed between the gate films and electrically connected to the first common electrode, and a gate PCB electrically connected to the gate films and the common voltage films.

In an example method for manufacturing an OLED apparatus according to the present invention, the method includes disposing an organic light-emitting element forming an organic light-emitting layer between first and second electrodes to which driving and common voltage respectively applied on a display panel, to emit light, connecting a gate driving circuit part to a first side of the display panel, forming a first common electrode on the first side, to electrically connect the first common electrode to the second electrode, connecting a data driving circuit part to a second side substantially perpendicular to the first side of the display panel, and forming a second common electrode to a third side facing the first side, to electrically connect the second common electrode to the second electrode.

The method may further include electrically connecting a first driving electrode to the first electrode of the second side and the data driving circuit part.

The method may further include forming a plurality of data films being connected to the second side and including a power applying line part, a data driving chip disposed on each data film, and a data PCB electrically connected to the data film, on the data driving circuit part.

The method may further include forming a plurality of substantially parallel gate films connected to the first side, a gate driving chip disposed on each gate film, common voltage films electrically connected to the first common electrode between gate films, and a gate PCB connected to the gate films and the common voltage films, on the gate driving circuit part.

In an example method for driving an OLED apparatus according to the present invention, the method includes forming an organic light-emitting layer between first and second electrodes, applying a gate signal from a gate driving circuit part connected to a first side of a display panel, applying a common voltage to a first common electrode from the gate driving circuit part, the first common electrode formed at the first side and electrically connected to the second electrode, applying a data signal from a data driving circuit part connected to a second side substantially perpendicular to the first side of the display panel, and applying the common voltage to a second common electrode from the data driving circuit part, the second common electrode formed at a third side facing the first side and electrically connected to the second electrode.

Applying the common voltage from the data driving circuit part may include applying one of a driving voltage and the common voltage from a power applying line part connected to the second side at both end portions substantially parallel with the second side, disposing a data driving chip on each data film, and electrically connecting a data PCB to the data films.

Applying the common voltage from the gate driving circuit part may include connecting a plurality of substantially parallel gate films to the first side, disposing a gate driving chip on each gate film, electrically connecting common voltage films to the first common electrode between the gate films, and electrically connecting a gate PCB to the gate films and the common voltage films.

According to the present invention, the driving and common voltages are simultaneously applied to the display panel through the data film of the data driving circuit part, so that the PCB that is conventionally used for applying the common voltage may be eliminated and the OLED apparatus may have a more simplified structure.

### BRIEF DESCRIPTION OF THE DRAWINGS

The above and other features and advantages of the present invention will become more apparent by describing in detailed example embodiments thereof with reference to the accompanying drawings, in which:

FIG. 1 is a plan view illustrating an organic light-emitting display (OLED) apparatus according to an example embodiment of the present invention;

FIG. 2 is a circuit diagram illustrating a pixel portion in FIG. 1;

FIG. 3 is a plan view illustrating a data film in FIG. 1;

FIG. 4 is a plan view illustrating an enlarged portion of FIG. 2; and

FIG. 5 is an enlarged view illustrating portion “A” in FIG. 4.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments of the invention are described herein with Reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Hereinafter, the present invention will be explained in detail with reference to the accompanying drawings.

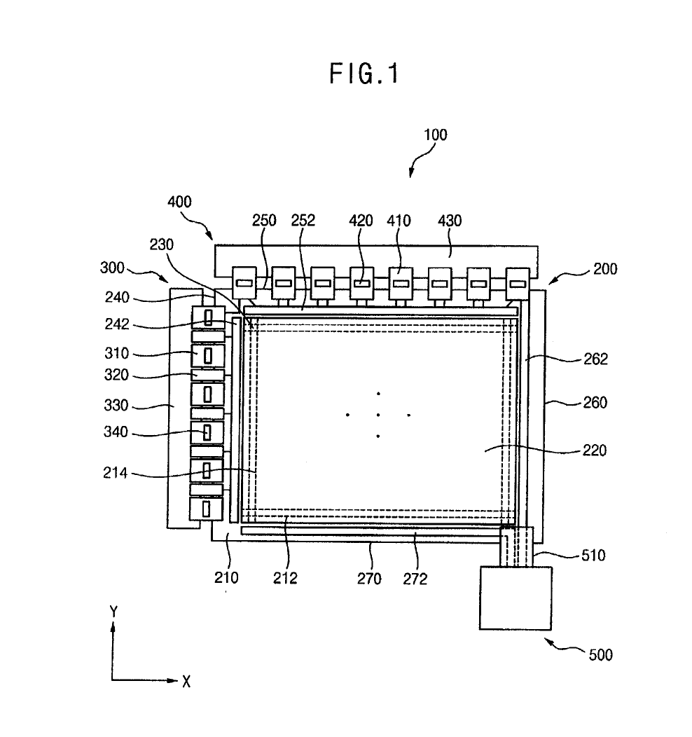

FIG. 1 is a plan view illustrating an organic light-emitting display (OLED) apparatus according to an example embodiment of the present invention.

Referring to FIG. 1, the OLED apparatus 100 according to the present example embodiment includes a display panel 200, a gate driving circuit part 300 and a data driving circuit part 400.

The display panel 200 includes an organic light-emitting element 220 disposed on an insulating layer 210 on which a thin-film transistor (TFT) is formed. The insulating layer 210 may include a transparent material such as glass, to transmit light. The organic light-emitting element 220 emits the light based on a driving voltage and a common voltage.

A plurality of gate lines 212 and a plurality of data lines 214 substantially perpendicular to each other are formed on the insulating layer 210. For example, the gate line 212 is formed along a first axis X, and the data line 214 is formed along a second axis Y substantially perpendicular to the first axis X. A pixel portion 230 is defined by the gate and data lines 212 and 214 on the insulating layer 210.

The gate driving circuit part 300 is electrically connected to a first side 240 of the display panel 200. The gate driving circuit part 300 applies a gate signal to a gate line 212. In addition, the gate driving circuit part 300 applies a common voltage to a first common electrode 242 formed at the first side 240.

For example, the gate driving circuit part 300 includes a plurality of substantially parallel gate films 310 connected to the first side 240 of the display panel 200, a common voltage film 320 electrically connected to the first common electrode 242 disposed between the first films 310, and a gate printed circuit board (PCB) 330 electrically connected to the gate films 310 and the common voltage films 320. In addition, the gate driving circuit part 300 may further include a gate driving chip 340 on the gate film 310. The gate driving chip 340 controls the gate signal.

The data driving circuit part 400 includes substantially parallel data films 410 electrically connected to a second side 250 of the display panel 200, a data driving chip 420 disposed on each data film 410, and a data PCB 430 connected to the data films 410.

The data film 410 applies the driving voltage or the common voltage at both sides. For example, the data film 410 applies a data signal to the data line 214 at a central portion of the data film 410.

The display panel 200 includes a second driving electrode 272 and a second common electrode 262 to respectively receive the driving voltage and common voltage from the data film 410. The second driving electrode 272 is lengthwise formed along the first axis X at the second side 250 of the display panel 200. The second common electrode 262 is lengthwise formed along the second axis Y at a third side 260 opposite to the first side 240 at which the first common electrode 242 is formed.

The second common electrode 262 is electrically connected to the data film 410 that is closest to the third side 260 among the data films 410. For example, current applied to the second common electrode 262 from the second driving electrode 272 is discharged through the data film adjacent to the third side 260.

According as a size of the OLED apparatus increases, the second driving electrode 272 may not apply enough driving voltage, so that additional second driving electrodes 272 may be formed on the display panel 200. The second driving electrode 272 is disposed at a fourth side 270 opposite to the second side 250 of the display panel 200 to apply additional current

However, the data film adjacent to the third side 260 may not have sufficient capacity to carry the increased current applied to the second common electrode 262 from the first and second driving electrodes 252 and 272. For example, the OLED apparatus 100 includes an additional power supply part 500 electrically connected to a second end of the second common electrode 262, which is opposite to a first end of the second common electrode 262, to which the data film 410 is electrically connected, and the common voltage is additionally applied, so that the additional current may be safely carried.

In addition, the power supply part 500 may be electrically connected to the second driving electrode 272, to apply the driving voltage. For example, the power supply part 500 is disposed at an edge where the fourth side 270 having the second driving electrode 272 and the third side 260 having the second common electrode meet each other.

The power supply part 500 may be electrically connected to the second driving electrode 272 and the second common electrode 262 by an additional power supply film 510. Alternatively, the power supply part 500 may be electrically connected to the second driving electrode 272 and the second common electrode 262 via a connector (not shown).

As described above, the OLED apparatus 100 applies the common voltage to the display panel 200 through the data film 410 most adjacent to the third side 260 of the display panel 200 and eliminates the conventional PCB disposed at the third side 260, so that the OLED apparatus 100 may have a more simplified structure.

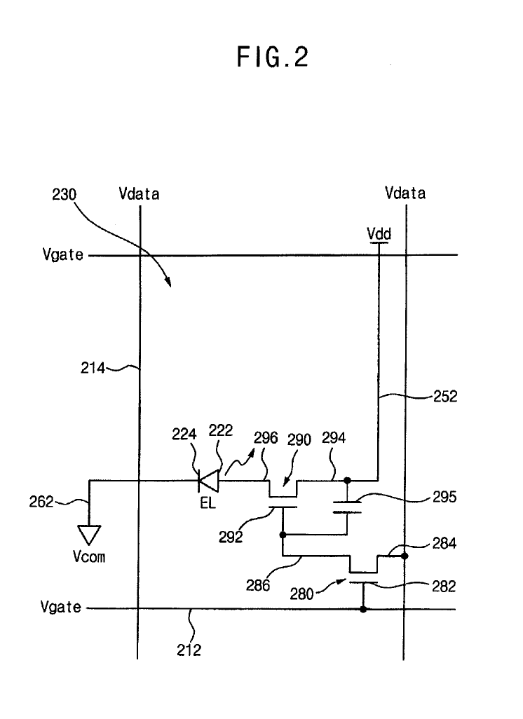

FIG. 2 is a circuit diagram illustrating a pixel portion in FIG. 1.

Referring to FIG. 2, the organic light-emitting element 220 includes an organic light-emitting layer, for example a light-emitting element EL disposed between first and second electrodes 222 and 224 to which the driving voltage Vdd and the common voltage Vcom are respectively applied.

The light-emitting element EL receives driving power through first and second TFTs 280 and 290 formed between the gate and data lines 212 and 214, to emit the light.

The first TFT 280 includes a first gate electrode 282 connected to the gate line 212, a first source electrode 284 connected to the data line 214, and a first drain electrode 286. Accordingly, when the gate signal, for example a gate voltage Vgate is applied to the first gate electrode 282 through the gate line 212, the first drain electrode 286 is electrically connected to the first source electrode 284, and thus receives the data signal, for example a data voltage Vdata from the data line 214.

In addition, the second TFT 290 includes a second gate electrode 292 connected to the first drain electrode 286 of the first TFT 280, a second source electrode 294 connected to the driving electrode 252, and a second drain electrode 296 connected to the light-emitting element EL. In FIG. 2, the driving electrode 252 includes the first and second driving electrodes 252 and 272 illustrated in FIG. 1, and for the convenience, the same reference numeral as the first driving electrode 252 is used. The common electrode 262 also includes the first and second common electrode, and for the convenience, the same reference numeral as the second common electrode 262 will be used.

Accordingly, when the data signal Vdata is applied to the second gate electrode 292 from the first drain electrode 286, the second drain electrode 296 is electrically connected to the second source electrode 294 and receives the driving voltage Vdd from the driving electrode 252.

The driving voltage Vdd is applied to the first electrode 222 of the light-emitting element EL. However, the second electrode 224 of the light-emitting element EL is always electrically connected to the common electrode 262 and receives the common voltage Vcom. Thus, the driving voltage Vdd and the common voltage Vcom are respectively applied to the first and second electrodes 222 and 224 of the light-emitting element EL, so that the light-emitting element EL emits the light.

The data signal applied to the second gate electrode 292 of the second TFT 290 may be unstable according to a switching state of the first TFT 280 and so on, an additional capacitor 295 is formed between the driving voltage Vdd and the first TFT 280, so that a more stable data signal may be applied to the second gate electrode 292.

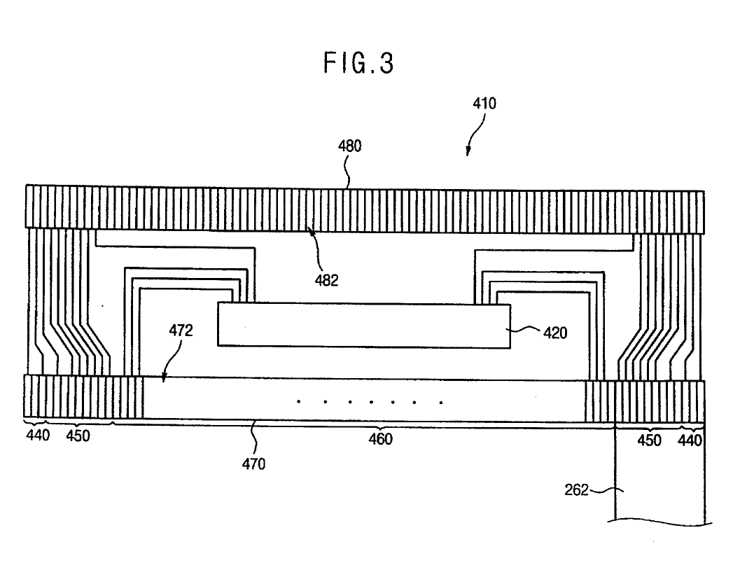

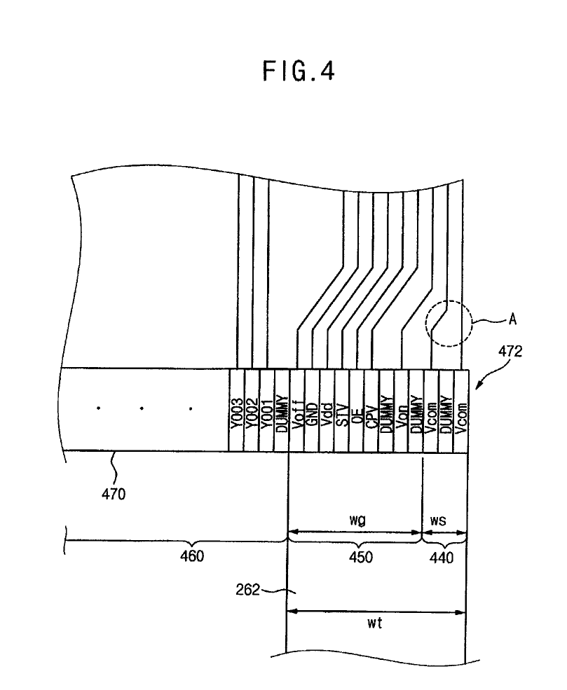

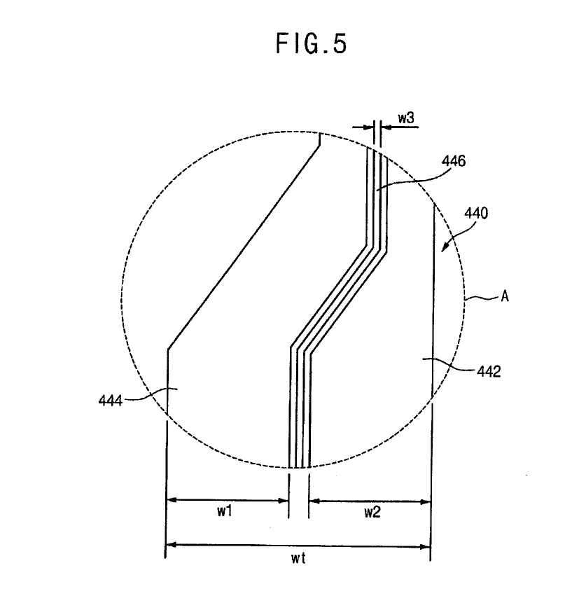

FIG. 3 is a plan view illustrating a data film in FIG. 1. FIG. 4 is a plan view illustrating an enlarged portion of FIG. 2. FIG. 5 is an enlarged view illustrating portion “A” in FIG. 4.

Referring to FIGS. 1, 3, 4 and 5, the data film 410 includes a power applying line part 440 electrically connected to the display panel 200 and the data printed circuit substrate 430, a gate signal applying line part 450 and a data applying line part 460.

The two power applying line parts 440 are formed at first and second end portions of the data film 410 along the first axis X. Two gate signal applying line parts 450 are formed adjacent to the power applying line part 440. The data applying line part 460 is disposed at a central portion of the data film 410 that is between the gate signal applying line parts 450.

First and second end portions of the power applying line part 440, the gate signal applying line part 450 and the data applying line part 460 are respectively exposed at a first end portion 470 and a second end portion 480 of the data film 410, which are respectively adjacent to the display panel 200 and the data PCB 430. In detail, the data film 410 includes a first pad portion 472 formed at the first end portion 470, and a second pad portion 482 formed at the second end portion 480.

A mask to form the power applying line part 440, the gate signal applying line part 450 and the data applying line part 460, preferably has a symmetric structure. Thus, the power applying line part 440, the gate signal applying line part 450 and the data applying line part 460 have symmetric line structures with respect to the data driving chip 420.

The power applying line part 440 may apply one of the driving voltage and the common voltage to the second driving electrode 272 or the second common electrode 262. When the data film 410 in FIG. 4 corresponds to the data film 410 disposed at a right end side of the data films 410 along the first axis X in FIG. 1, all the power applying line parts 440 apply the common voltage to the second common electrode 262.

When the power applying line part 440 of the data films 410 in FIG. 4 corresponds to the data film 410 disposed at the central portion of the display panel 200, the power applying line part 440 applies the driving voltage to the second driving electrode 272. Alternatively, the power applying line part 440 may apply the common voltage to the second common electrode 262.

The power applying line part 440 includes first and second power lines 442 and 444. The first and second power lines 442 and 444 correspond to a portion of the data film 410 and have relatively larger widths than other terminals. For example, the first and second power lines 442 and 444 have first and second widths w1 and w2 between about 1.25 mm and about 1.75 mm. In addition, a dummy line 446 having a third width w3 of about 0.03 mm is disposed between the first and second power lines 442 and 444.

A line width ws of the power applying line part 440 corresponding to the portion of the data film 410 is the sum of the first, second and third widths w1, w2 and w3, and is between about 2.5 mm and about 3.5 mm. Preferably, the line width ws is about 3.0 mm.

The gate signal applying line part 450 applies the gate signal to the gate driving circuit part 300. For example, generally, the gate signal applying line part 450 may include STV, OE and CPV lines transferring a clock signal controlling the gate driving circuit part 300, and Voff, Gnd, Vdd and Von lines supplying the gate driving circuit part 300 with electric power.

Since the data film 410 has a symmetric line structure with respect to the data driving chip 420, the gate signal applying line part 450 is substantially effective in the data film 410 corresponding to the first side 240 of the display panel 200 at which the gate driving circuit part 300 is disposed.

For example, the gate signal applying line part 450 corresponding to the third side 260 of the display panel has substantially useless terminals, so that the gate signal applying line part 450 corresponding to the third side may be used for applying the common voltage. The gate signal applying line part 450 has a width wg between about 1.5 mm and about 2.5 mm, and preferably has the width wg of about 2.0 mm.

In FIG. 4, being different from reality, the width wg of the gate signal applying line part 450 is illustrated or exaggerated to be larger than the width ws of the power applying line part 440 to illustrate names of each terminal of the first pad portion 472.

The second common electrode 262 is electrically connected to the data film 410 with a width wt between about 4 mm and about 6 mm which is the sum of the power applying line part 440 and the gate signal applying line part 450. Preferably, the width wt is about 5 mm. In FIG. 4, the second common electrode 262 having the same width as the width wt which is the sum of the power applying line part 440 and the gate signal applying line part 450 is illustrated, but the width of the second common electrode 262 may be substantially larger than the width wt by a predetermined distance.

Accordingly, the data film 410 additionally connects the gate applying line part 450 to the second common electrode 262, so that the data film 410 may be flexibly adapted to the increased capacity of the common voltage according as the size of the OLED apparatus 100 increases.

According to the present invention, the common voltage is applied to the display panel through the data film corresponding to the third side of the display panel, so that the conventional printed circuit substrate disposed to correspond to the third side is eliminated. Thus, the OLED apparatus may have a more simplified structure.

In addition, the data film applies the common voltage to the second common electrode through the width of about 5 mm that is the sum of the power applying line part and the gate signal applying line part, so that the data film may be flexibly adapted to the increased capacity of the common voltage according as the size of the OLED apparatus increases.

Having described the example embodiments of the present invention and its advantage, it is noted that various changes, substitutions and alterations can be made herein without departing from the spirit and scope of the invention as defined by appended claims.

What is claimed is:

1. An organic light-emitting display (OLED) apparatus comprising:
a display panel including an organic light-emitting element having an organic light-emitting layer disposed between a first electrode to which a driving voltage is applied and second electrodes to which a common voltage is applied, the first and second electrodes being formed on a substrate having a thin-film transistor (TFT) formed thereon;
a gate driving circuit part connected to a first side of the display panel for applying a gate signal and for also applying a common voltage to a first common electrode that is formed at the first side and is electrically connected to the second electrode; and
a data driving circuit part connected to a second side of the display panel which is substantially perpendicular to the first side for applying a data signal and for also applying the common voltage to a second common electrode formed at a third side opposite to the first side which is electrically connected to the second electrode.

2. The OLED apparatus of claim 1, wherein the display panel further comprises a first driving electrode that is formed at the second side and is electrically connected to the first electrode and the data driving circuit part.

3. The OLED apparatus of claim 2, wherein the data driving circuit part comprises:
a plurality of data films connected to the second side and having a power applying line part formed on the data films, the power applying line part being formed at both sides substantially perpendicular to the second side for applying one of the driving and common voltages;
a data driving chip disposed on each of the data films; and
a data printed circuit board (PCB) electrically connected to the data films.

4. The OLED apparatus of claim 3, wherein the second common electrode is electrically connected to the power applying line part of the data film adjacent to the third side.

5. The OLED apparatus of claim 4, wherein each of the data films further comprises a gate signal applying line part that is formed adjacent to the power applying line part to apply the gate signal to the gate driving circuit part, and
the gate signal applying line part corresponding to the third side of the display panel being electrically connected to the second common electrode for applying the common voltage.

6. The OLED apparatus of claim 5, wherein the width of the power applying line part electrically connected to the second common electrode, and the width of the gate signal applying line part are between about 4 mm and about 6 mm.

7. The OLED apparatus of claim 6, wherein the display panel further comprises:
a second driving electrode formed at a fourth side corresponding to the second side; and
a power supply part disposed at an edge at which the third and fourth sides meet each other for applying the driving voltage to the second driving electrode and for applying the common voltage to the second common electrode.

8. The OLED apparatus of claim 7, wherein the gate driving circuit part comprises:
a plurality of substantially parallel gate films connected at the first side;
a gate driving chip disposed on each gate film;
common voltage films disposed between the gate films and electrically connected to the first common electrode; and
a gate PCB electrically connected to the gate films and the common voltage films.

9. A method for manufacturing an OLED apparatus, the method comprising:
disposing an organic light-emitting element forming an organic light-emitting layer between first and second electrodes to which driving and common voltages are respectively applied on a display panel to emit light;
connecting a gate driving circuit part to a first side of the display panel;
forming a first common electrode on the first side, to electrically connect the first common electrode to the second electrode;
connecting a data driving circuit part to a second side substantially perpendicular to the first side of the display panel; and
forming a second common electrode to a third side facing the first side, to electrically connect the second common electrode to the second electrode.

10. The method of claim 9, further comprising electrically connecting a first driving electrode to the first electrode of the second side and the data driving circuit part.

11. The method of claim 10, further comprising forming on the data driving circuit part a plurality of data films connected to the second side and including a power applying line part, a data driving chip disposed on each data film, and a data PCB electrically connected to the data film.

12. The method of claim 11, further comprising forming a plurality of substantially parallel gate films connected to the first side, a gate driving chip disposed on each gate film, common voltage films electrically connected to the first common electrode between gate films, and a gate PCB connected to the gate films and the common voltage films, on the gate driving circuit part.

13. A method for driving an OLED apparatus, the method comprising:
forming an organic light-emitting layer between first and second electrodes;
applying a gate signal from a gate driving circuit part connected to a first side of a display panel;
applying a common voltage to a first common electrode from the gate driving circuit part, the first common electrode formed at the first side and electrically connected to the second electrode;
applying a data signal from a data driving circuit part connected to a second side substantially perpendicular to the first side of the display panel; and
applying the common voltage to a second common electrode from the data driving circuit part, the second common electrode formed at a third side facing the first side and electrically connected to the second electrode.

14. The method of claim 13, wherein applying the common voltage from the data driving circuit part comprises:
applying one of a driving voltage and the common voltage from a power applying line part connected to the second side at both end portions substantially parallel with the second side;
disposing a data driving chip on each data film; and
electrically connecting a data PCB to the data films.

15. The method of claim 14, wherein applying the common voltage from the gate driving circuit part comprises:
connecting a plurality of substantially parallel gate films to the first side;
disposing a gate driving chip on each gate film;
electrically connecting common voltage films to the first common electrode between the gate films; and
electrically connecting a gate PCB to the gate films and the common voltage films.
